(19) United States
(12) Patent Application Publication
(10) Pub. No.: US 2005/0234696 A1
(43) Pub. Date: Oct. 20, 2005

(54) Automated agent-based method for identifying infrastructure interdependencies

(75) Inventors: Michael J. North, Wheaton, IL (US); Daniel J. Miller, Naperville, IL (US); William Howard Thomas II, King George, VA (US); Scott D. DeWald, Fredericksburg, VA (US)

Correspondence Address: FOLEY & LARDNER, 321 NORTH CLARK STREET, SUITE 2800, CHICAGO, IL, 60610-4764, US

(73) Assignee: The University of Chicago

(21) Appl. No.: 10/825,572

(22) Filed: Apr. 15, 2004

(51) Int. Cl. G06F 9/45

(52) U.S. Cl. 703/22

(57) ABSTRACT

This invention relates to a method, apparatus, and means for simulating interdependent infrastructures. This may involve selecting a subset of an interdependent infrastructure system, equivalencing the subset, creating a plurality of agents to model with the subset, and simulating multi-scale agent interactions. It may also include selecting subsets based on geographic region or selecting components for two way analysis or simulating across concurrent time, or selecting a plurality of infrastructures to simulate and connecting the infrastructures by screening candidate interconnections and assigning candidates a likelihood of connection, or identifying connections extending outside of the subset and calculating flow limit for each connection extending outside the subset, or creating agents from templates and data for a infrastructure and creating agents at equivalenced connections, or advancing agent conditions through time and re-equivalencing the infrastructure and continuing until a steady state is achieved.

This invention was made with government support under Contract No. W-31-109-ENG-38 awarded to the Department of Energy. The Government has certain rights in this invention.

### FIELD OF THE INVENTION

This invention relates generally to a method for determining the interdependencies between various infrastructures. More particularly, this invention relates to an agent-based simulation of interdependent infrastructures with automatic dynamic equivalencing.

### BACKGROUND OF THE INVENTION

Infrastructures such as electric power, natural gas, and telecommunication systems consist of a large number of components and participants that are diverse in both form and capability. A Complex Adaptive System (CAS) is a system of such components that interact while adapting to their environment. These infrastructures exhibit unstable coherence in spite of constant disruptions and a lack of central planning, a characteristic of CAS.

Complexity Theory is the study of order within otherwise chaotic systems that often focuses on Complex Adaptive Systems. Large-scale, interconnected infrastructures such as electric power, natural gas and telecommunication systems are Complex Adaptive Systems. The systems employed in any given industry are highly complex with dynamic feedback and response mechanisms. Through years of technological evolution, the processes and materials that make modern life possible have grown increasingly interconnected. By leveraging the advances in other sectors, individual industries have improved their ability to efficiently compete in the marketplace. Through this leveraging, the nation's infrastructures have coalesced in varying degrees, forming larger interdependent systems. These systems, operating under high stress conditions, can be close to a breaking point at which any additional stress results in a dramatic change in the behavior of the system. The systems undergo what is akin to a phase-change in a physical system and shift to a drastically different state. Modeling such infrastructures is a daunting task. Seven basic features common to all Complex Adaptive Systems have been identified—four properties (aggregation, nonlinearity, flows, and diversity) and three mechanisms for change (tagging, internal models, and building blocks).

Different agents act on each infrastructure. The environment surrounding an agent can act as a dominant state variable that structures and sequences the agent's behavior. Thus, the agent's memory is composed of the agent's own storage capacity plus that of the environment. Agents must have a discrete set of rules that are activated when appropriate environmental cues occur. The environment structures an agent's behavior. This is similar to a situation involving ants building an anthill. The new work any ant does is prompted by the existing layout of the hill. This work modifies the anthill, resulting in a feedback loop. The critical issue is feedback that allows the environment to be part of an agent's memory.

A model is any representation of a system and a simulation is a model with direct structural and temporal correspondence with a system. A wide variety of models exist to study physical infrastructures in isolation. These models generally take an engineering view of a single infrastructure. Obtaining a physical system representation in a particular industry is mostly a matter of obtaining the right data and software packages. Much of this information is available in the commercial marketplace. When interdependency requirements are imposed on the representative model, the challenges grow. The distinction between behaviors at the microscopic and macroscopic levels becomes important.

Simulating infrastructures in isolation is beneficial for design, maintenance, and operation. However, considering the importance of interdependencies, models must examine the relationships between infrastructures as well as the components within a given infrastructure. Simulating these relationships between infrastructures is only the beginning. The natural approach to interdependence modeling is to acquire the proper software packages for several industries and to try running them together. However, even if the effort were successful, the resulting model would lack the operators and other decision-makers that affect the commodity or service delivery.

Most large-scale infrastructures are highly interconnected with other infrastructures. Each interconnected infrastructure affects all of the others. For example, the proliferation of Internet-based electric power markets highlights the increasingly interdependent nature of the electric power and telecommunications industries.

Corporations and other large organizations, acting within markets, operate infrastructures according to a myriad of marketplace, legal, regulatory, and financial considerations. Simulating these organizational choices in the appropriate physical context is important to better understand large-scale, interconnected infrastructures.

In addition to the financial realm, interdependencies also arise in the form of the physical connections; e.g., electricity providers increasingly depend on telecommunication services providers to manage their power systems. This telecommunication capacity is often owned by the electricity providers themselves, but it is still prone to the same types of problems as other telecommunication systems. Conversely, virtually all telecommunication switches depend on the electric power for long-term operation, with limited short-term backups. Furthermore, some electricity providers are beginning to directly enter the telecommunication services market. For example, some electrical utilities are now beginning to offer high-bandwidth Ethernet service in metropolitan cities using cables run through existing electrical conduits.

The electric power and telecommunications infrastructures have been carefully buffered from one another by conscious design decisions throughout the systems. This buffering must be properly understood to effectively model these systems. However, it is important to note that this buffering has both strong temporal and geographic limitations. Temporally, the buffering provided by components such as storage batteries lasts for limited periods of time. Geographically, both the electric power and telecommunications infrastructures often share the same rights of way reducing the independence of the systems. Modeling the financial and energy flows in this way allows for the formation of the feedback loops that could exist between these infrastructures. It also allows for explicit accounting of financial as well as other resources, giving an indication of the organizational possibilities for survival, growth, acquisition, and bankruptcy within the industry.

Viewing large-scale, interconnected infrastructures with complex physical architectures, such as Complex Adaptive Systems, can provide many new insights. The Complex Adaptive System approach emphasizes the specific evolution of integrated infrastructures and their participants' behavior, not just simple trends or end states. The adaptation of the infrastructure participants to changing conditions is paramount. Also, the effects of random events and uncertainty are explicitly considered. One powerful computational approach to understanding Complex Adaptive Systems is agent-based simulation (ABS).

An ABS includes a set of agents and a framework for simulating their decisions and interactions. ABS is related to a variety of other simulation techniques including discrete event simulation and distributed artificial intelligence or multi-agent systems. While many traits are shared, ABS is differentiated from these approaches by its focus on achieving “clarity through simplicity” as opposed to deprecating “simplicity in favor of inferential and communicative depth and verisimilitude.” It offers the opportunity to gain new insights into the operation of large-scale, interconnected infrastructures and explicitly represents the behaviors of individual decision-makers.

Adaptation, in the biological sense, is the process whereby an organism adjusts itself to its environment. In an agent simulation, an agent can adapt by changing its rules with experience, thereby positioning itself to better fit its environment. If agents do not learn or are unable to adapt quickly enough to a changing environment, they can be replaced by others likely to perform better. This is social learning versus individual learning. Both aspects of learning are present in a Complex Adaptive System model. Agents are specialized software-engineering objects possessing some form of intelligence or self-direction.

ABS has been used to study isolated emergent systems as varied as computer networks, electrical power infrastructures, equities, foreign exchange, and integrated economies. Furthermore, some of this work involved the manual interconnection of interdependent systems such as interwoven electrical and natural gas infrastructures.

Emergent behavior, a key feature of ABS, occurs when the behavior of a system is more complicated than the simple sum of the behavior of its components. Sometimes called “swarm intelligence,” since it often arises from a group of individuals cooperating to solve a common problem, diversity drives emergent behavior and provides a source for new ideas or approaches. The key is to balance the level of diversity. Too little diversity leads to stagnation. Too much diversity prevents exploitation of existing good ideas. Achieving a balance between these extremes of diversity is crucial to system survival.

### SUMMARY OF THE INVENTION

The present invention is directed to managing critical infrastructures such as electric power, natural gas and telecommunication systems, during emergency and crisis situations and for planning to manage such occurrences.

One object of the present invention is to provide a system and method for automatically determining infrastructure interdependency and analysis on complex infrastructures including a large number of agents. These infrastructures exhibit unstable coherence in spite of constant disruptions and a lack of central planning, a characteristic of Complex Adaptive Systems. The present invention leverages the fact that infrastructures are Complex Adaptive Systems to perform integrated automatic interdependency identification and analysis.

A further object of the present invention is to provide a system and method for modeling both physical and economic agent behavior in an interdependent infrastructure. Agents are both physical and economic in nature, and they have input, output, and decision-making capability. Economic agents include energy and transmission companies and consumers. Specifically, economic agents of the telecommunication system include regional operating companies, local telephone service companies, long distance telephone service companies, wireless services companies, modern-based Internet service providers, customers, and regulators. Decision-makers can be characterized as having different objectives and constraints with a limited ability to process information. They receive incomplete information and have a limited set of choices. In the physical system, physical components are regarded as agents, but economic factors and policy set the environment in which they operate.

A further object of the present invention is to provide a system and method for modeling agent behavior in an interdependent infrastructure over variable time scales. System behavior is determined by decisions made over a variety of time scales, and the creation of agent models that cover the full range of time scales is critical to understanding complex infrastructure interdependencies. Human economic decision-making dominates longer time scales while physical laws dominate shorter time scales. The focus of each agent's rules varies to match the time scale in which it operates.

A further object of the present invention is to provide a system and method for reducing bias associated with the constituent disciplines. A model that provides sufficient environmental stimuli to each one of these agents permits each to respond in its element. With adequate linkages, events ripple through both the physical and the financial realms.

A further object of the invention is provide a system and method for modeling both the physical and financial infrastructures in the environment defined by policy. To have a model that captures both engineering and market constraints allows a wide variety of policy questions to be explored before implementation. Adjustments in the behavioral rules for one class of decision-makers could have significant physical and financial impacts. Market shifts that create high demand for a particular commodity could be stymied by insufficient capacity to meet that demand. This imbalance would feed back into the market with unpredictable results, depending on available alternatives. Thus, local interactions can have system-wide impact.

A further object of the invention is to provide a system and method for exploring a larger range of possible responses in an interdependent infrastructure. Such a model could expose potential behaviors that would not otherwise be considered. The model is not constrained in its ability to adapt to new circumstances. The observation of emergent behaviors in a reasonable model forces one to consider the possible responses.

The above referenced objects, advantages and features of the invention together with the organization and manner of operation thereof will become apparent from the following detailed description when taken into conjunction with the accompanying drawings wherein like elements have like numerals throughout the drawings described below.

### BRIEF DESCRIPTION OF THE DRAWINGS

FIG. 1 is an overview flowchart of a simulator for interdependent infrastructures according to one embodiment of the invention;

FIG. 2 is a representation of disconnected infrastructures;

FIG. 3 is a representation of candidate infrastructure connections;

FIG. 4 is a representation of properly connected infrastructures;

FIG. 5 is an overview flowchart of a selector according to one embodiment of the invention;

FIG. 6 is a representation of a complete set of interconnected infrastructures;

FIG. 7 is a representation of a selected infrastructure subset;

FIG. 8 is a representation of a equivalenced infrastructure;

FIG. 9 is an overview flowchart of an equivalencer according to one embodiment of the invention;

FIG. 10 is a representation of created agents;

FIG. 11 is an overview flowchart a method of creating agents according to one embodiment of the invention;

FIG. 12 is an example of automatic simultaneous multi-scale agent simulation of multiple interdependent infrastructures across concurrent time scales;

FIG. 13 is an overview flowchart of a simulator according to one embodiment of the invention;

FIG. 14 is a representation of a dynamically equivalenced infrastructure with disabled and protected infrastructure components;

FIG. 15 is a representation of a dynamically equivalenced infrastructure with disabled and protected infrastructure components after a simulation execution cycle; and

FIG. 16 is a representation of a dynamically equivalenced infrastructure with disabled and protected infrastructure components after a second simulation execution cycle.

### DETAILED DESCRIPTION OF THE PREFERRED EMBODIMENTS

Applying ABS to interdependent infrastructures allows such networks to be understood as more than just wires. Interdependent infrastructures may then be electronically managed as complete, dynamic systems. An example is the integrated, systems-level computational perspective ABS has provided to electrical and natural gas infrastructure research. This holistic computational perspective allows both the physical and human dimensions of complex systems such as communication networks to be anticipated and managed online, in real time.

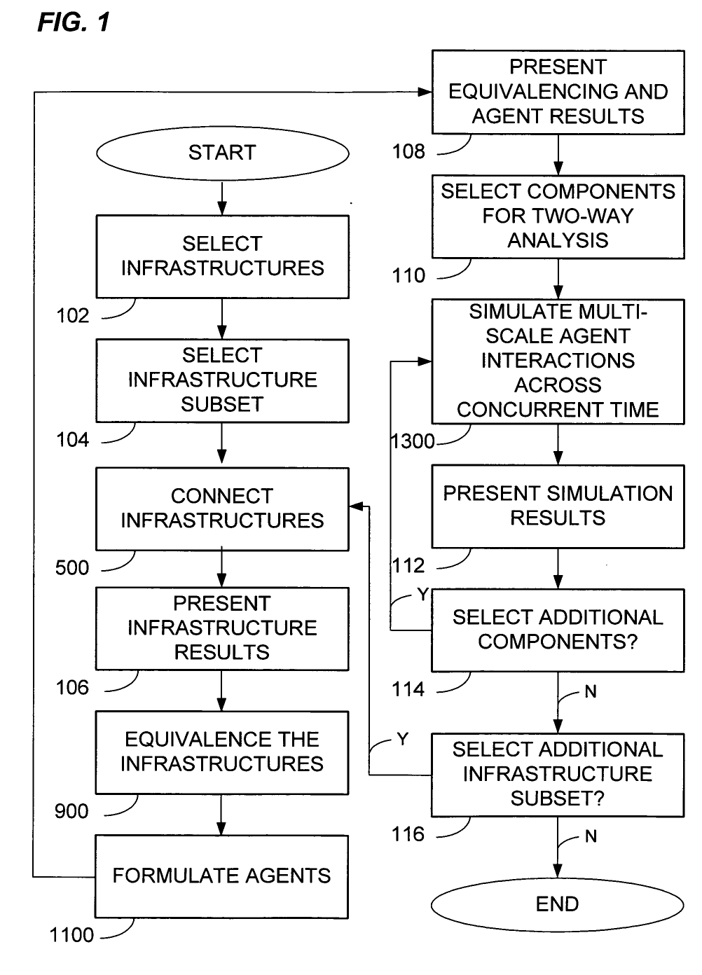

The overview flowchart shown in FIG. 1 shows a simulator for interdependent infrastructures according to one embodiment of the invention. These stages combine in a unique way to allow an analyst to perform multi-scale agent-based simulation of interdependent infrastructures with automatic dynamic equivalencing.

In step 102, a user selects what infrastructures are to be analyzed. For example, the user could choose to analyze the interdependencies between the gas infrastructure and electric infrastructure. The user could choose any number of infrastructures to analyze. At step 104, the user selects a subset of each infrastructure the user wishes to analyze. This subset may be based on different characteristics such as geography. It should be appreciated that step 102 could occur after step 104.

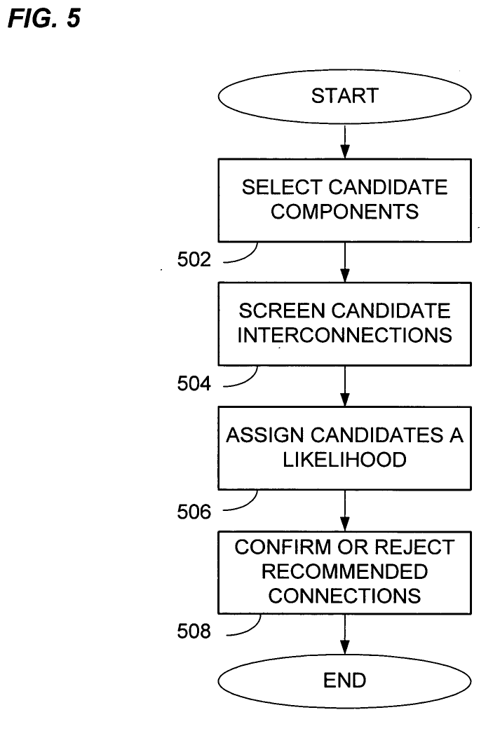

At step 500, the selected infrastructures are interconnected. This interconnection is further detailed in FIG. 5. Next at step 106, the user is presented with the interconnected infrastructure.

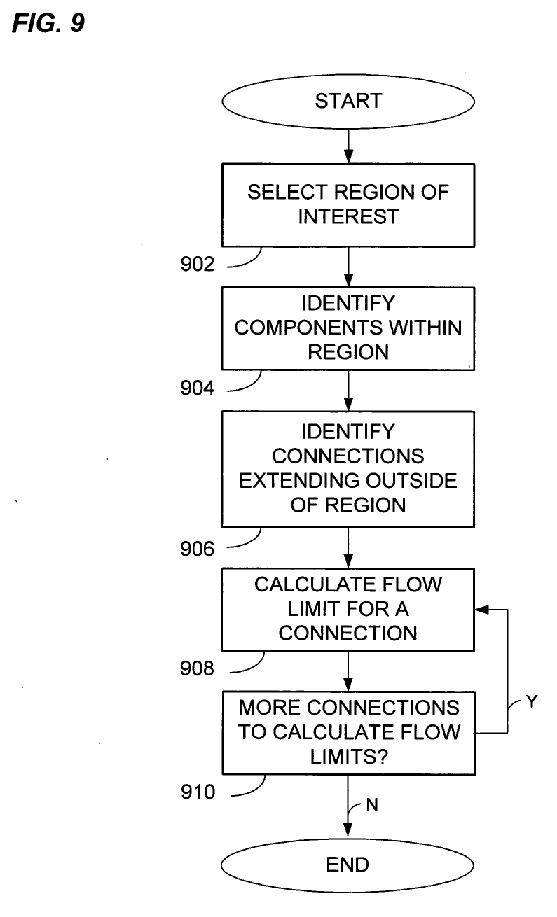

At step 900, the interconnected infrastructure is equivalenced in order to account for the part of the infrastructure that is outside of the selected subset. This equivalencing step is further detailed in FIG. 9.

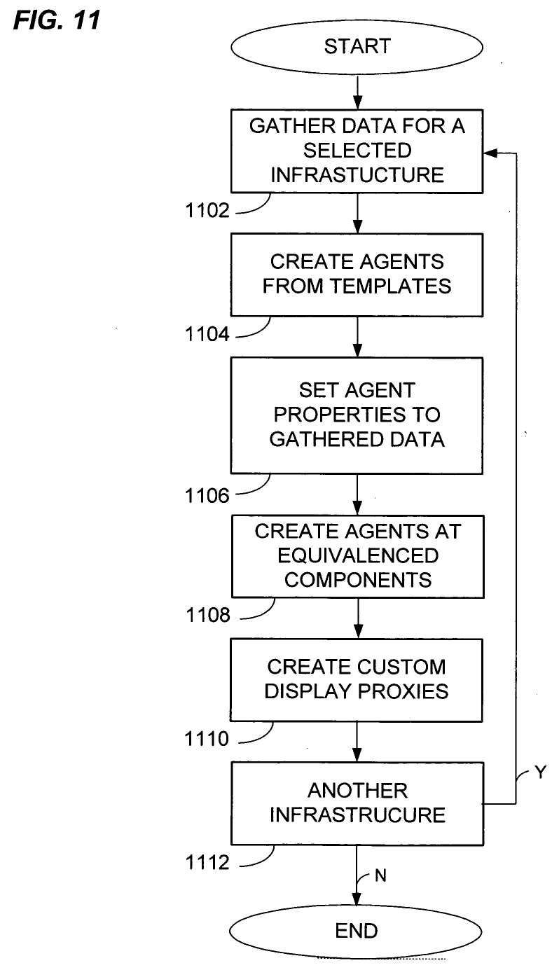

At step 1100, agents are created in order to interacted with the equivalenced infrastructure. This agent creation step is further detailed in FIG. 11. An agents is a software representation of a decision-making unit. The agent's behavior is modeled with a set of simple decision rules that are able to change and adapt over time in response to repeated interactions with other agents and with the environment. The interactions among individual agents may be simple, but the complex chains of interdependencies among agents may result in counter-intuitive, unpredictable, and chaotic patterns of system behavior. A model of two interdependent infrastructures might contain five layers, one for each of the physical infrastructures, one for each of the corresponding industries, and a consumer layer that is common to all infrastructures. The infrastructure layers contain physical network models. Not every physical agent is modeled in the infrastructures; rather, the physical infrastructure is modeled to the level of detail required to reproduce aggregate system features, such as total energy flow, at a reasonable level of accuracy.

At step 108, the equivalencing and agent results are presented to the user. At step 110, the user selects components for two way automatic dependency analysis. Certain components may be either designated as disabled or protected in order to facilitate the user's desire to analyze different situations.

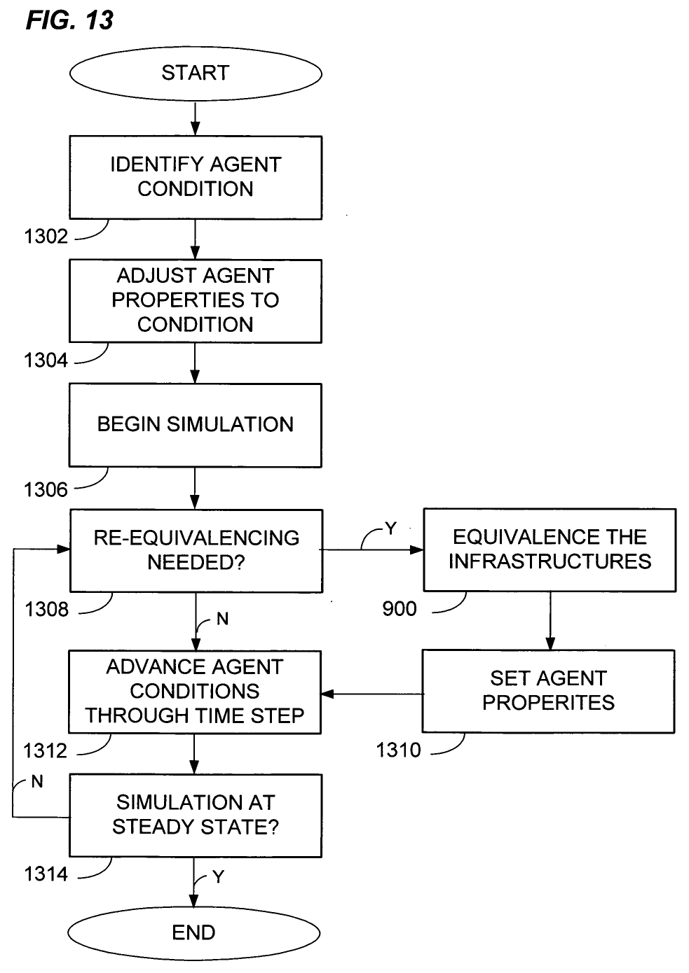

At step 1300, the multi-scale agent interactions are simulated across concurrent time. This simulation is further detailed in FIG. 13. At step 112, the simulation results may be presented to the user. As the simulation is run, the results may be presented to the user after each simulation step. This presentation allows the user to study which infrastructures become threatened after different lengths of time. When a protected component is threatened, the user is made aware that action needs to be taken. At step 114, the user chooses whether to go back to select additional components for two way automatic dependency analysis and go back to step 1300.

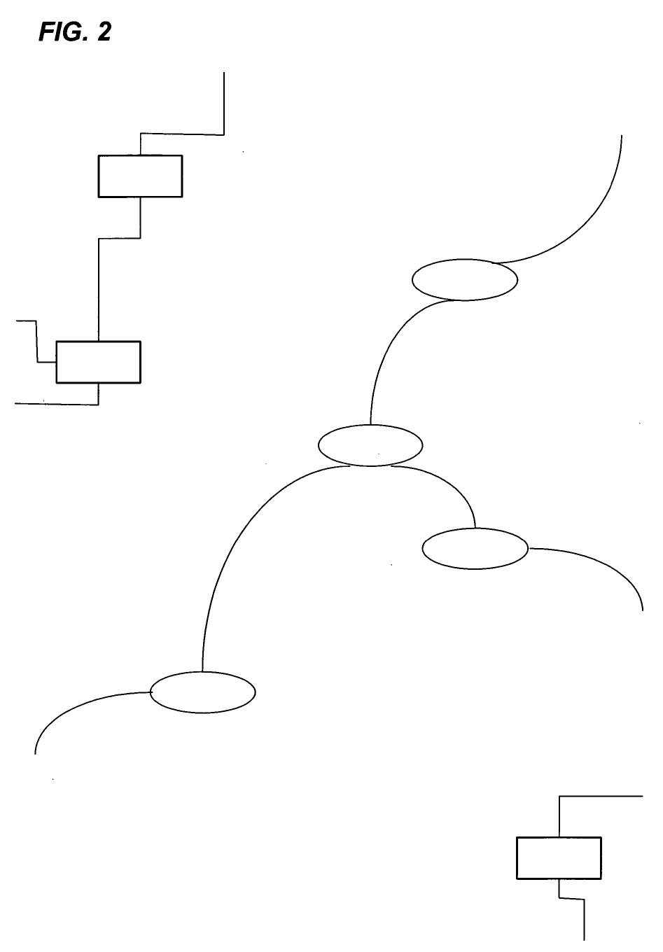

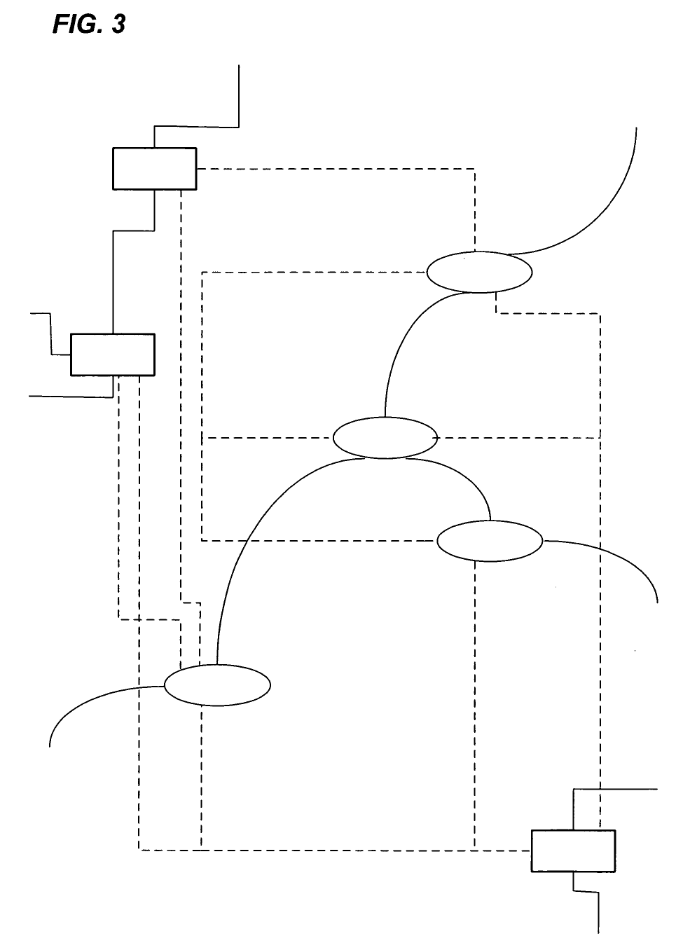

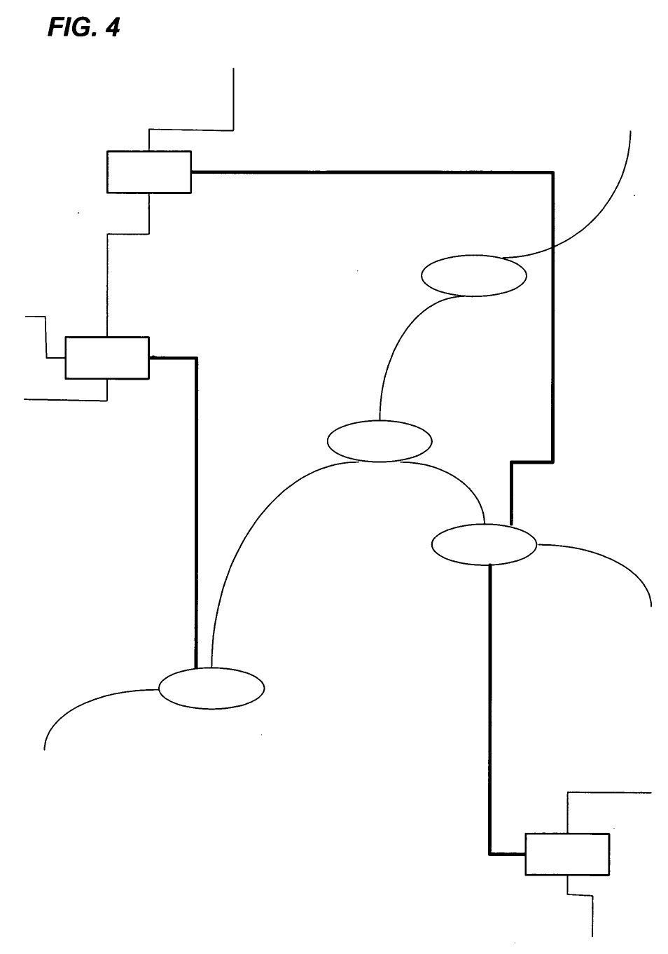

FIG. 5 is a representation of the interconnection of infrastructures for step 500 of FIG. 1. FIG. 2 shows a representation of disconnected infrastructures. At step 502, candidate interconnections between the infrastructure are generated. FIG. 3 shows a representation of candidate connections. This step could be accomplished either manually or automatically. At step 504, the candidate connections are screened, and at step 506 the candidate connections are assigned a likelihood of the connection. This likelihood can be based on a number of different factors such as physical attributes, including the length of the proposed connection, and financial attributes. At step 508, each candidate connection may be confirmed or rejected. This step can be done manually based on the likelihoods assigned in step 506, or it can be done manually after presenting the user with the likelihoods assigned in step 506. The user may only be presented with the most probable candidates based on the likelihoods. The user may also only be presented with the candidates with a likelihood above a predetermined amount. FIG. 4 shows a representation of a properly connected infrastructure.

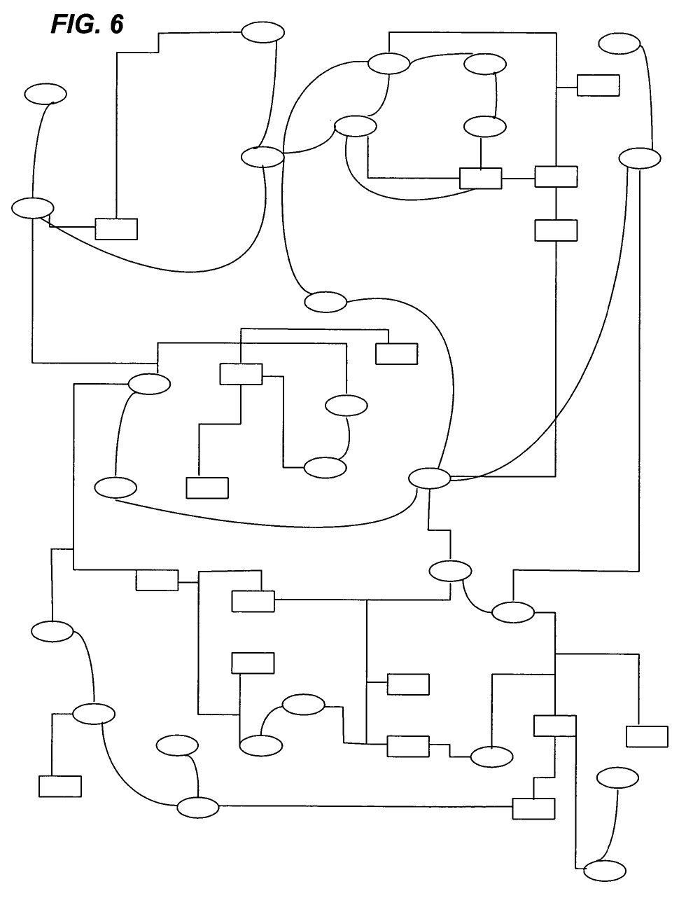

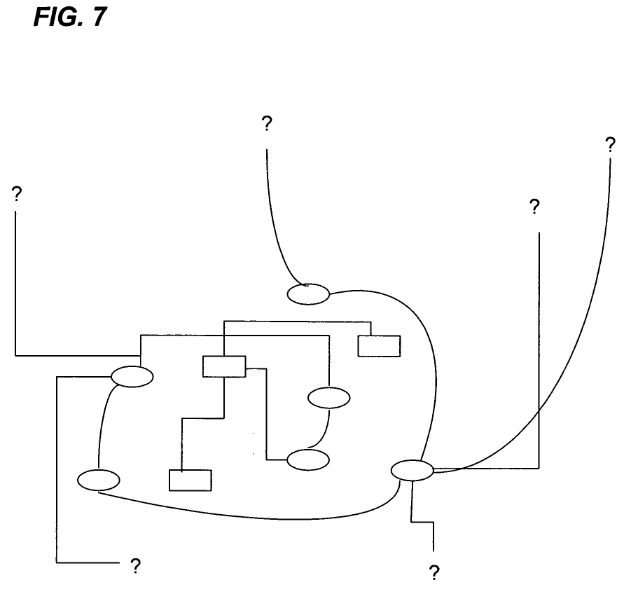

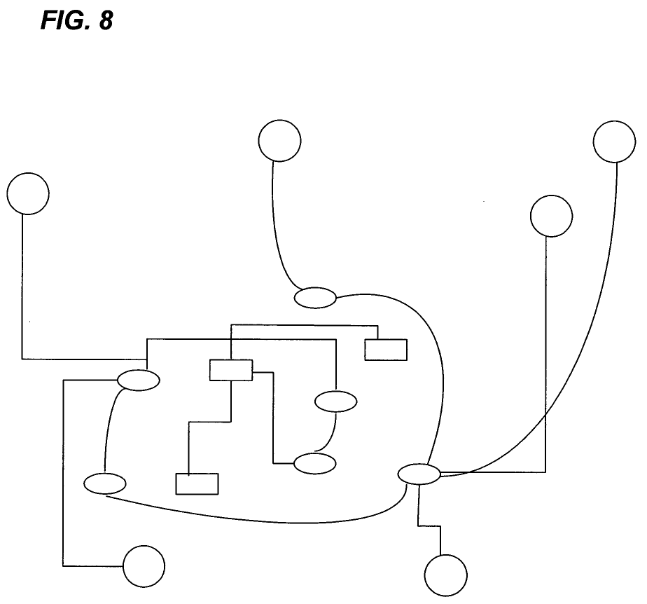

FIG. 9 shows an overview flow chart of an equivalencer. FIG. 6 shows a representation of a complete set of interconnected infrastructures. At step 902, the user selects a region of interest from the set of interconnected infrastructures. FIG. 7 shows a representation of a selected infrastructure subset from FIG. 6. Once a region of interest is selected there may be many disconnected components on the edges of the selected region. At step 904, the equivalencer identifies the components of the infrastructures that are located within the selected region. At step 906, the equivalencer identifies the components of the infrastructures that extend outside of the selected region. These disconnected components cannot simply be deleted since they can provide important inflows to and outflows from the selected region. The equivalencer provides proper equivalent infrastructure components to represent all of the infrastructure components external to the selected region regardless of the number. At step 908, the equivalencer calculates the flow limit for one of the components identified in step 906. At step 910, the equivalencer determines if there are components that were identified in step 906 that have not had a flow limit calculated for. If so, the equivalencer returns to step 908. FIG. 8 shows a representation of an equivalenced infrastructure.

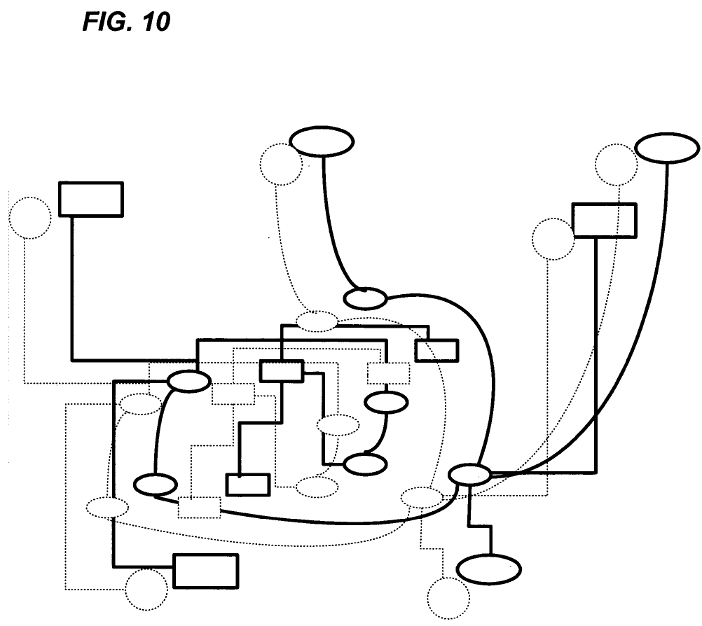

FIG. 11 shows a flow chart for creating agents according to one embodiment of the invention. At step 1102, the program gathers data for one of the selected infrastructures. This data may include spatial and attribute data. At step 1104, templates are used in order to create the appropriate agents. At step 1106, the properties of the agents created in step 1104 are adjusted to the data gathered in step 1102. At step 1108, different agents may be created at equivalenced components. The properties of these agents may be set to the flow limits calculated during the equivalencing done at step 900. At step 1110, custom display proxies may be created to control the agent presentation. At step 1112, if there are other selected infrastructures to create agents for, the agent creation step 1100 returns to step 1102. If not, the agent creation step 1100 is terminated. FIG. 10 shows a representation of an infrastructure with created agents.

FIG. 13 shows a flow chart of a simulator. At step 1302, a user specifies an agent condition. At step 1304, the simulator adjusts the agent's properties to the specified condition. At step 1306, the simulator begins the simulation loop. At step 1308, the simulator determines if the interdependent infrastructures require re-equivalencing. If the interdependent infrastructures do require re-equivalencing, the simulator equivalences the infrastructures. This process may use the equivalencer detailed at step 900 and FIG. 9, or it may use a different equivalencing process. This ability to re-equivalence during the simulation makes the equivalencing process dynamic. After the re-equivalencing, the simulator automatically sets the agent properties at step 1310. The simulator then goes to step 1312, which is also where the simulator goes after step 1308 if no re-equivalencing is needed. At step 1312, the simulator automatically advances the agent conditions through a time step. This time step may be of a variable length. At step 1314, if the simulator has reached steady state, the simulator ends otherwise it returns to step 1308.

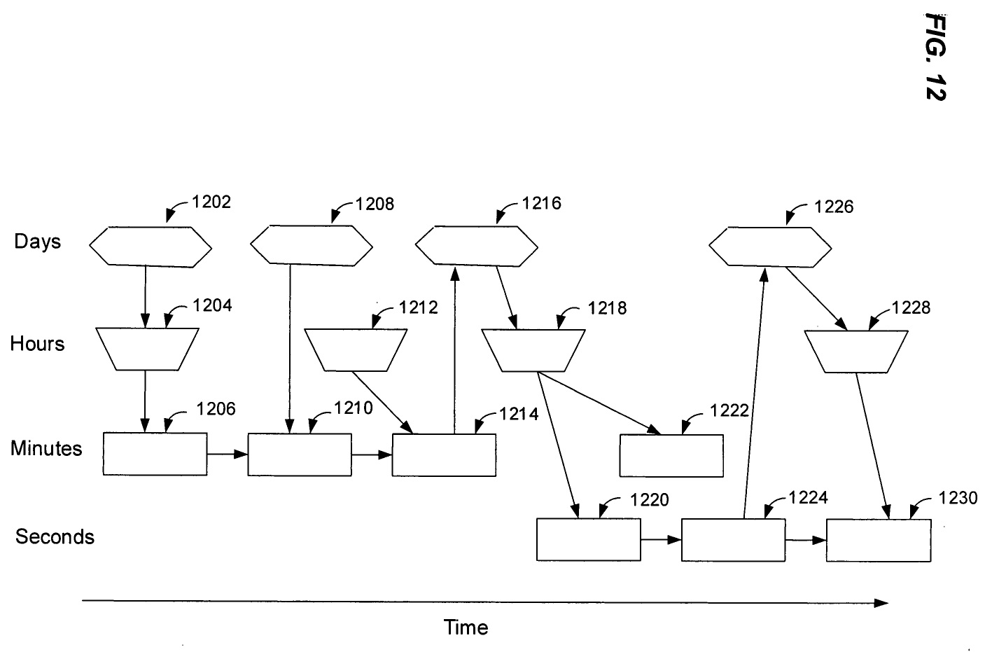

FIG. 12 shows an example of automatic simultaneous multi-scale agent simulation of multiple interdependent infrastructures across concurrent time scales according to one embodiment of the invention. At item 1202, a corporation lowers natural gas reserve margins to increase profits. At item 1204, the natural gas system operators slow storage filling. At item 1206, the natural gas storage levels drop. At item 1208, unseasonably cold weather increases natural gas and electricity demands. At item 1210, natural gas levels drop further. At item 1212, an accident damages a natural gas source pipeline. At item 1214, the natural gas storage is depleted. At item 1216, corporations are forced to reduce natural gas service to customers. At item 1218, natural gas operators cut service to selected customers. At item 1220, selected electricity generators lose natural gas fuel service. At item 1222, selected natural gas customers lose service. At item 1224, electricity generation fails. At item 1226, corporations are forced to reduce electricity service to customers. At item 1228, electricity operators cut service to selected customers. At item 1230, selected electricity customers lose service. As shown in FIG. 12, each of these items occur at different time scales (such as days, hours, minutes, or seconds) and have a rippling effect throughout the interdependent infrastructure.

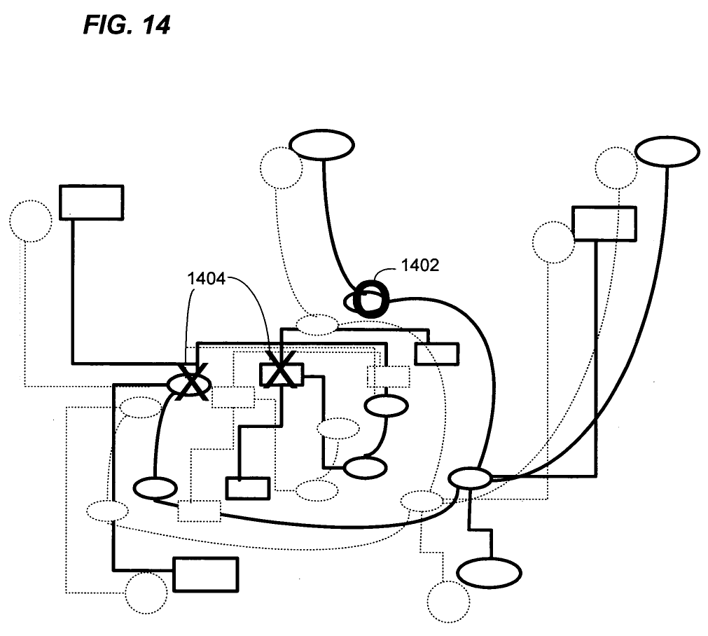

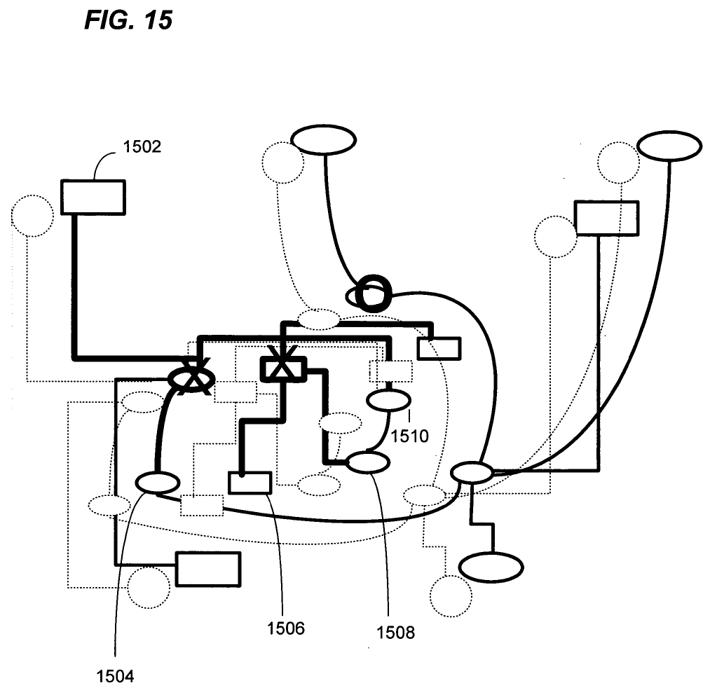

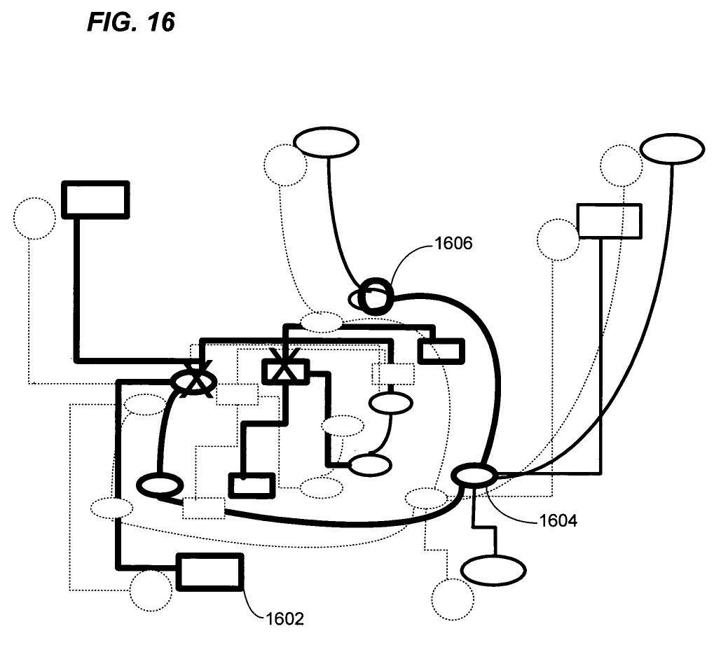

FIGS. 14-16 show another example of an interdependent infrastructure being simulated across time. FIG. 14 shows the same connected infrastructure with created agents represented in FIG. 10. However, the node labeled 1402 has been specified as protected by the user and the nodes labeled 1404 have been specified as disabled by the user. The user can now simulate the infrastructure across time to analyze the effect of the disabled nodes. FIG. 15 shows the results of the simulation after one simulation execution cycle. As shown, nodes 1502, 1504, 1506, 1508, and 1510 have now become threatened from the disabled nodes, but the protected node is still safe. FIG. 16 shows the results of the simulation after a second simulation execution cycle. As shown, nodes 1602, 1604, and 1606 are now threatened. One of those nodes, 1606, represents the protected node. The user now realizes that corrective action will be needed to further protect the node.

While a number of embodiments are disclosed herein, many variations are possible which remain within the concept and scope of the invention, and these variations would become clear to one of ordinary skill in the art after perusal of the specification, drawings and claims herein. For example, many of the steps outlined above are not in a unique order and could be taken in different orders achieving the same results.

1. A method for simulating interdependent infrastructures, comprising the steps of:
selecting a subset of an interdependent infrastructure system;
equivalencing the subset;
creating a plurality of agents to interact with the subset; and
simulating multi-scale agent interactions.

2. The method of claim 1, wherein the subset is being selected to represent a geographic region.

3. The method of claim 1, further comprising the steps of:
selecting components for two way analysis, and wherein the simulation occurs across concurrent time.

4. The method of claim 1, further comprising the steps of:
selecting a plurality of infrastructures to simulate; and
connecting the infrastructures, including the steps of
screening candidate interconnections; and
assigning candidates a likelihood of connection.

5. The method of claim 1, wherein the equivalencing step includes the steps of:
identifying connections extending outside of the subset; and
calculating flow limit for each connection extending outside the subset.

6. The method of claim 1, wherein the creating agents step includes the steps of:
creating agents from templates and data for a infrastructure; and
creating agents at equivalenced connections.

7. The method of claim 1, wherein the simulating step includes the steps of:
advancing agent conditions through time;
re-equivalencing the infrastructure; and
continuing the simulation until a steady state is achieved.

8. An apparatus for simulating interdependent infrastructures, comprising:
a selector for selecting a subset of an interdependent infrastructure system;
an equivalencer for equivalencing a subset;
a plurality of agents for modeling the subset; and
a simulator for simulating multi-scale agent interactions within the subset.

9. The apparatus of claim 8, wherein the selector comprises a candidate screener for determining the likelihood of interconnections.

10. The apparatus of claim 8, wherein the equivalencer comprises a flow limit calculator for equivalencing connections extending outside a subset.

11. The apparatus of claim 8, wherein the agents comprise:
a data gatherer for creating agents; and
templates for creating agents.

12. The apparatus of claim 8, wherein the simulator comprises a time advancer for advancing agent conditions through time.

13. A system for simulating interdependent infrastructures, comprising:
means for selecting infrastructures from an interdependent infrastructure system;
means for equivalencing the selected infrastructures;
means for creating agents for the intended use interacting with the infrastructures; and
means for simulation for the intended use of analyzing the infrastructures.

14. The system of claim 13, wherein the means for equivalencing comprises means for calculating a flow limit.

15. The system of claim 13, wherein the means for simulation comprises:
means for re-equivalencing;
means for advancing conditions through time steps; and
means for determining steady state.
